(19) United States
(12) Patent Application Publication
(10) Pub. No.: US 2023/0153767 A1
(43) Pub. Date: May 18, 2023

(54) METHOD AND INTERNET OF THINGS SYSTEM FOR WASTE CLEANING VOLUME PREDICTION IN SMART CITY

(71) Applicant: CHENGDU QINCHUAN IOT TECHNOLOGY CO., LTD., Chengdu (CN)

(72) Inventors: Zehua SHAO, Chengdu (CN); Junyan ZHOU, Chengdu (CN); Bin LIU, Chengdu (CN); Yongzeng LIANG, Chengdu (CN); Yuefei WU, Chengdu (CN)

(73) Assignee: CHENGDU QINCHUAN IOT TECHNOLOGY CO., LTD., Chengdu (CN)

(21) Appl. No.: 18/154,841

(22) Filed: Jan. 15, 2023

(30) Foreign Application Priority Data
Nov. 14, 2022 (CN) 202211416880.1

(51) Int. Cl. G06Q 10/30; G06V 20/52

(52) U.S. Cl. CPC G06Q 10/30; G06V 20/52

(57) ABSTRACT

The embodiments of the present disclosure provide a method for waste cleaning volume prediction in a smart city, the method being executed based on a management platform of an Internet of Things (IoT) system for waste cleaning volume prediction in a smart city, including: obtaining reference evaluation information of a target area within a first historical time period; and determining, based on the reference evaluation information, cleaning information of the target area at a target time; the cleaning information including a waste cleaning volume.

### CROSS-REFERENCE TO RELATED APPLICATION

This application claims priority of Chinese Patent Application No. 202211416880.1, filed on Nov. 14, 2022, the contents of which are entirely incorporated herein by reference.

### TECHNICAL FIELD

The present disclosure relates to the technical field of an Internet of Things, and in particular, to a method and Internet of Things system for waste cleaning volume prediction in a smart city.

### BACKGROUND

With a development of economy and an improvement of people's living standards, a waste generated by social activities has increasingly become a problem that pollutes the environment and affects people's production and life. If the waste is not cleared and transported in time, it will cause a large volume of waste accumulation, affecting the living and working environment, which is not conducive to people's health. Due to a continuous expansion of an urban scale and an increase of an urban population, urban garbage removal and transportation are also increasingly testing a management method and management efficiency of relevant management departments. How to deal with the waste generated in life and work efficiently and timely depends on whether waste removal and transportation needs of each urban area can be accurately grasped, and then precise policies may be implemented.

Therefore, it is hoped to propose a method for waste cleaning volume prediction in a smart city to improve an accuracy and efficiency of the waste cleaning volume prediction, and to realize an automation and intelligence of the waste cleaning volume prediction.

### SUMMARY

One or more embodiments of the present disclosure provide a method for waste cleaning volume prediction in a smart city, the method being executed based on a management platform of an Internet of Things (IoT) system for waste cleaning volume prediction in a smart city, including: obtaining reference evaluation information of a target area within a first historical time period; and determining, based on the reference evaluation information, cleaning information of the target area at a target time, the cleaning information including a waste cleaning volume.

One or more embodiments of the present disclosure provide an IoT system for waste cleaning volume prediction in a smart city, including a user platform, a service platform, a management platform, a sensing network platform, and an object platform; the management platform includes a general management platform database and a plurality of management sub-platforms, and each management sub-platform in the plurality of management sub-platforms corresponds to a different target area; the sensing network platform includes a plurality of sensing network sub-platforms, and each sensing network sub-platform corresponds to a different target area; the object platform is used to obtain reference evaluation information of the target area in a first historical time period, and transmit the reference evaluation information to the corresponding management sub-platform based on the sensing network sub-platform corresponding to the target area; the management sub-platform is used to determine, based on the reference evaluation information, cleaning information of the target area at a target time, and transmit, based on the general management platform database, the cleaning information to the service platform; the cleaning information including a waste cleaning volume; and the service platform is used to transmit the cleaning information to the user platform.

One or more embodiments of the present disclosure provide a non-transitory computer-readable storage medium storing computer instructions, wherein when reading the computer instructions in the storage medium, a computer implements the method for waste cleaning volume prediction in a smart city according to any of the above.

### BRIEF DESCRIPTION OF THE DRAWINGS

The present disclosure will be further described by way of example embodiments, which will be described in detail with reference to the drawings. These examples are not limiting, and in these examples, the same numbers refer to the same structures, wherein:

FIG. 1 is a schematic diagram illustrating an exemplary application scenario of an Internet of Things (IoT) system for waste cleaning volume prediction in a smart city according to some embodiments of the present disclosure;

FIG. 2 is a platform structure diagram illustrating an exemplary IoT system for waste cleaning volume prediction in a smart city according to some embodiments of the present disclosure;

FIG. 3 is a flowchart illustrating an exemplary method for waste cleaning volume prediction in a smart city according to some embodiments of the present disclosure;

FIG. 4 is a schematic diagram illustrating an exemplary process for obtaining stall information according to some embodiments of the present disclosure;

FIG. 5 is a schematic diagram illustrating an exemplary process for determining cleaning information based on a waste estimation model according to some embodiments of the present disclosure;

FIG. 6 is a flowchart illustrating an exemplary process for determining the cleaning information according to some embodiments of the present disclosure;

FIG. 7a is a schematic diagram illustrating an exemplary first feature image according to some embodiments of the present disclosure; and

FIG. 7b is a schematic diagram illustrating an exemplary area clustering according to some embodiments of the present disclosure.

### DETAILED DESCRIPTION

To illustrate the technical solutions of the embodiments of the present disclosure more clearly, the following briefly introduces the drawings used in the description of the embodiments. Obviously, the drawings in the following description are only some examples or embodiments of the present disclosure. For those skilled in the art, the present disclosure may further be applied to other similar situations according to these drawings without any creative effort. Unless obviously obtained from the context or the context illustrates otherwise, the same numeral in the drawings refers to the same structure or operation.

It should be understood that “system”, “device”, “unit” and/or “module” as used herein is a method used to distinguish different assemblies, elements, parts, sections, or assemblies at different levels. However, these words may be replaced by other expressions if they serve the same purpose.

As shown in the present disclosure and claims, unless the context clearly dictates otherwise, the words “a”, “an”, “one” and/or “the” are not intended to be specific in the singular and may include the plural. Generally speaking, the terms “comprising” and “including” only imply that the clearly identified operations and elements are included, and these operations and elements do not constitute an exclusive list, and the method or apparatus may further include other operations or elements.

Flowcharts are used in the present disclosure to illustrate operations performed by a system according to the embodiment of the present disclosure. It should be understood that the preceding or following operations are not necessarily performed in the exact order. Instead, the various operations may be processed in reverse order or simultaneously. At the same time, other operations may be added to these procedures, or an operation or operations may be removed from these procedures.

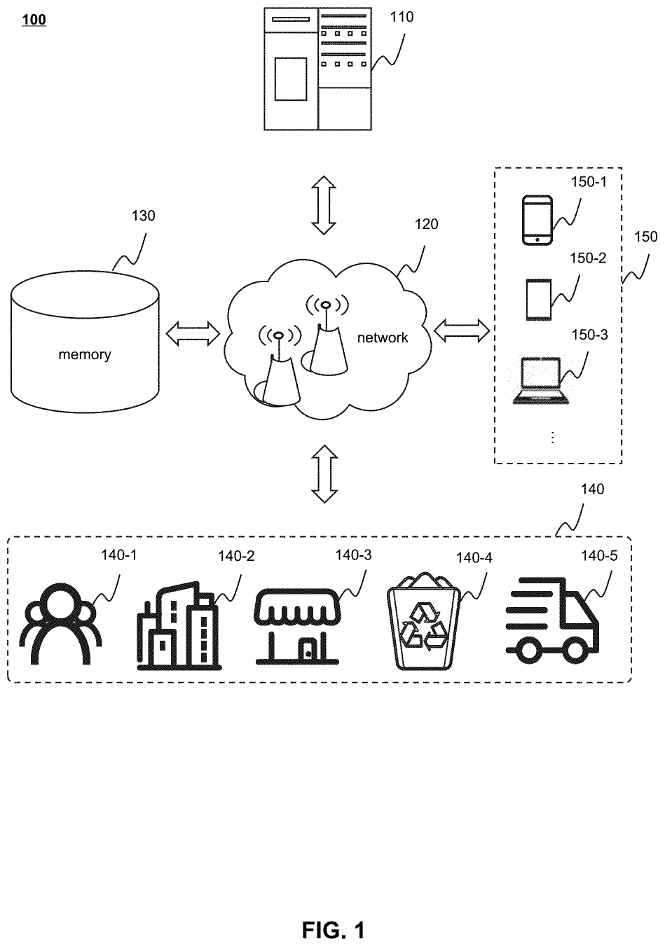

FIG. 1 is a schematic diagram illustrating an exemplary application scenario of an Internet of Things (IoT) system for waste cleaning volume prediction in a smart city according to some embodiments of the present disclosure. As shown in FIG. 1, an application scenario 100 of the IoT system for waste cleaning volume prediction in a smart city may include a processing device 110, a network 120, a memory 130, data information 140 and a terminal 150.

In some embodiments, the processing device 110 may be used to process information and/or data related to the application scenario 100. For example, the processing device 110 may be used to determine cleaning information based on reference evaluation information. In some embodiments, the processing device 110 may be a single server or a server group. In some embodiments, the processing device 110 may be local or remote.

The network 120 may facilitate an exchange of the information and/or data. In some embodiments, one or more assemblies of the application scenario 100 (e.g., the processing device 110, the memory 130, the terminal 150) may send the information and/or data to other assemblies of the application scenario 100 via the network 120. For example, the processing device 110 may obtain the reference evaluation information from the memory 130 via the network 120.

The memory 130 may be used to store data and/or instruction related to the waste cleaning volume prediction in a smart city. In some embodiments, the memory 130 may store the data information 140. In some embodiments, the memory 130 may store data and/or instruction used or executed by the processing device 110 to accomplish the exemplary methods described in the present disclosure. In some embodiments, the memory 130 may be implemented on a cloud platform.

In some embodiments, the memory 130 may be connected to the network 120 to communicate with one or more assemblies of the application scenario 100 (e.g., the processing device 110, the memory 130, the terminal 150). One or more assemblies of the application scenario 100 may access data or instruction stored in the memory 130 via the network 120. In some embodiments, the memory 130 may be directly connected to or in communication with one or more assemblies of the application scenario 100 (e.g., the processing device 110, the memory 130, the terminal 150). In some embodiments, the memory 130 may be a part of the processing device 110 or may be a separate memory.

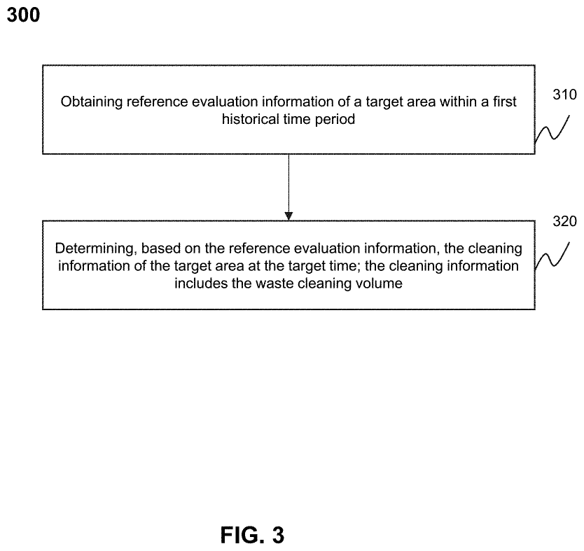

The data information 140 is information that can be used to predict the waste cleaning volume in the city, which can further be referred to as the reference evaluation information. In some embodiments, the data information 140 may include at least one of population information 140-1, building information 140-2, stall information 140-3, trash can configuration information 140-4, logistics information 140-5, etc. For more contents about the reference evaluation information, please refer to FIG. 3 and its related descriptions.

The terminal 150 may refer to one or more terminals or software used by a user. In some embodiments, the user may include a staff of a city management department, a city environmental protection management department, an ecological environment management department, etc. In some embodiments, the terminal 150 may include a mobile phone 150-1, a tablet computer 150-2, a laptop computer 150-3, or a combination of one or more thereof. In some embodiments, the user may obtain or issue data and/or instruction through the terminal 150. For example, the user may obtain the cleaning information determined by the processing device 110 through the terminal 150. For another example, the user may issue an instruction to query the cleaning information of a certain area through the terminal 150.

It should be noted that the application scenario 100 of the IoT system for waste cleaning volume prediction in a smart city is provided for illustrative purposes only, and is not intended to limit the scope of the present disclosure. For those skilled in the art, various modifications or changes may be made based on the descriptions of the present disclosure. For example, the application scenario may further include a data collection device. For another example, the application scenario 100 may be implemented on other devices to achieve similar or different functions. However, these changes and modifications do not depart from the scope of the present disclosure.

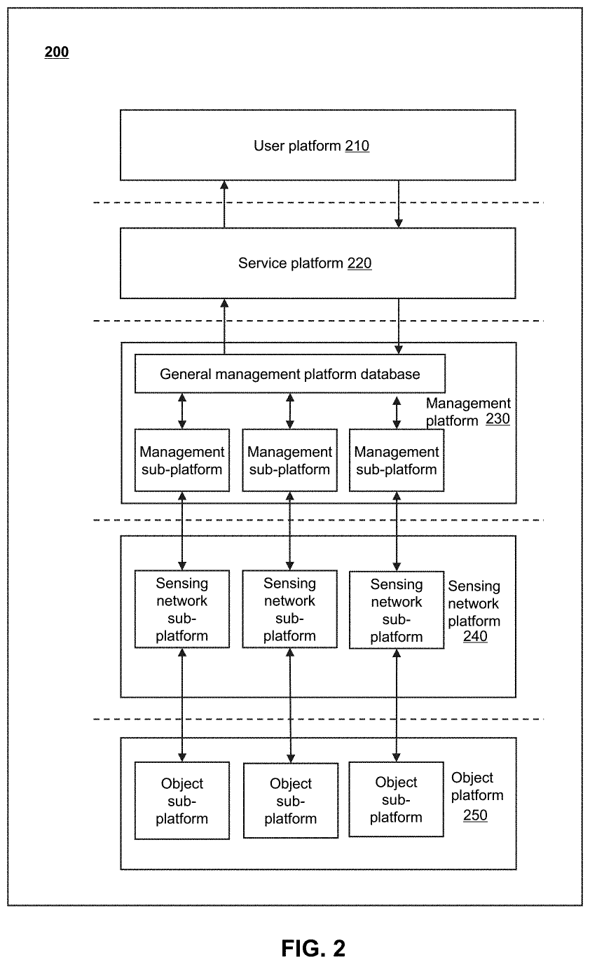

FIG. 2 is a platform structure diagram illustrating an exemplary IoT system for waste cleaning volume prediction in a smart city according to some embodiments of the present disclosure. In some embodiments, the IoT system for waste cleaning volume prediction in a smart city 200 may include a user platform 210, a service platform 220, a management platform 230, a sensing network platform 240 and an object platform 250.

The user platform 210 may be a user-facing service interface. In some embodiments, the user platform 210 may receive information from the user and/or the service platform. For example, the user platform 210 may receive input from the user. For another example, the user platform 210 may receive information fed back to the user from the service platform, such as cleaning information. In some embodiments, the user platform 210 may be configured to feed back the received information to the user. In some embodiments, the user platform 210 may be configured to issue data and/or instruction to the service platform, e.g., issue a query instruction for the cleaning information.

The service platform 220 may be a platform for a preliminary processing of the information. In some embodiments, the service platform may be configured to interact with the user platform and the management platform for information and/or data. For example, the service platform 220 may obtain the cleaning information query instruction from the user platform, upload the cleaning information to the user platform, etc. For another example, the service platform 220 may issue the cleaning information query instruction to the management platform, and obtain the cleaning information from the management platform, etc.

The management platform 230 may refer to an IoT platform that coordinates the connection and cooperation between various functional platforms, and provides a perception management and control management. In some embodiments, the management platform 230 may be configured to determine the cleaning information within a target area based on reference evaluation information, and the cleaning information may include the waste cleaning volume. In some embodiments, the reference evaluation information may include at least one of population information, building information, stall information, logistics information, and trash can configuration information. In some embodiments, the reference evaluation information may include a historical waste cleaning volume of a reference area and the target area.

In some embodiments, the management platform 230 may include a general management platform database and a plurality of management sub-platforms. In some embodiments, each of the plurality of management sub-platforms corresponds to a different target area, and each management sub-platform may process the reference evaluation information of the corresponding target area uploaded by the sensing network platform to determine the cleaning information of the corresponding target area at a target time.

In some embodiments, each management sub-platform may upload the determined cleaning information corresponding to the target area to the general management platform database. In some embodiments, the general management platform database may upload the cleaning information to the service platform in an aggregated form or in a divided form according to different areas.

In some embodiments, the management platform 230 may be further configured to determine the stall information based on the processing of a monitoring image of the target area through an image recognition model.

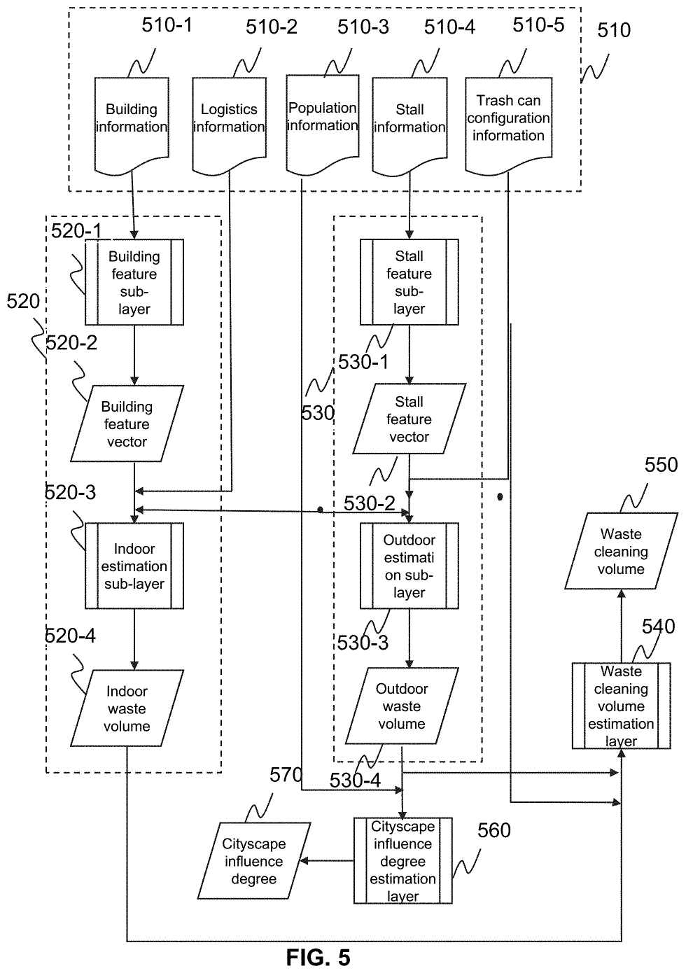

In some embodiments, the management platform 230 may be further configured to determine, based on the process of the reference evaluation information by the waste estimation model, the waste cleaning volume in the target area at the target time. For more contents about the waste estimation model and the determining the waste cleaning volume based on the waste estimation model, please refer to FIG. 5 and the related descriptions.

The sensing network platform 240 may be a platform that realizes an interactive engagement between the management platform and the object platform. In some embodiments, the sensing network platform 240 may receive an instruction to obtain the reference evaluation information issued by the management platform, and issue the instruction to the target platform. In some embodiments, the sensing network platform 240 may be configured to receive the reference evaluation information from the object platform and upload the received reference evaluation information to the management platform.

In some embodiments, the sensing network platform 240 may include a plurality of sensing network sub-platforms, and each sensing network sub-platform corresponds to a different target area. In some embodiments, each sensing network sub-platform is in a one-to-one correspondence with each management sub-platform, and in a one-to-one correspondence with each object sub-platform.

In some embodiments, each sensing network sub-platform may perform information and/or data interaction with the corresponding management sub-platform and object sub-platform. For example, each sensing network sub-platform may receive the instruction for obtaining the reference evaluation information issued by the corresponding management sub-platform, and issue the instruction to the corresponding object sub-platform. For another example, each sensing network sub-platform may receive the reference evaluation information uploaded by the corresponding object sub-platform, and upload the reference evaluation to the corresponding management sub-platform.

The object platform 250 may be a functional platform for a generation of perception information and a final execution of control information. In some embodiments, the object platform 250 may be configured as a monitoring device to obtain the reference evaluation information. For example, a road surveillance camera based on the target area may obtain the trash can configuration information. In some embodiments, the object platform 250 may include object sub-platforms corresponding to different target areas, and each object sub-platform may be implemented by the monitoring device or a sensing device. The object sub-platforms corresponding to different areas may upload the collected reference evaluation information to the corresponding sensing network sub-platforms, and the sensing network sub-platforms may upload the information to the management sub-platforms for processing. Different management sub-platforms may issue instructions to the object sub-platforms to collect the reference evaluation information of the areas based on the corresponding sensing network sub-platforms, and the corresponding object sub-platforms may execute the instructions.

It should be noted that the above description of the IoT system and its modules for waste cleaning volume prediction in a smart city is only for the convenience of description, and does not limit the present disclosure to the scope of the illustrated embodiments. It can be understood that for those skilled in the art, after understanding the principle of the IoT system, various modules may be combined arbitrarily, or form a sub-system to connect with other modules without departing from the principle.

FIG. 3 is a flowchart illustrating an exemplary method for waste cleaning volume prediction in a smart city according to some embodiments of the present disclosure. In some embodiments, a process 300 may be performed by a management platform. As shown in FIG. 3, the process 300 includes the following operations.

In 310, obtaining reference evaluation information of a target area within a first historical time period.

The target area refers to an urban area where a waste cleaning volume prediction is needed. For example, the target area may be an area formed based on an administrative division, such as a certain administrative district, a certain community, a certain street, etc. In some embodiments, the target area may be determined based on population information, building information, etc. For example, a building for office, residence and commerce at the same location may be determined as three different target areas according to a use status and a location of the building.

The first historical time period refers to a time period before the current time. For example, the first historical time period may be several hours, one day, etc. before the current time. In some embodiments, a duration of the first historical time period may be determined based on an actual waste volume in the city. For example, for an area with a relatively large waste volume, the first historical time period may be determined as a few hours (such as 4 hours) before the current time, and for an area with a relatively small waste volume, the first historical time period may be determined as one day before the current time, etc.

The reference evaluation information refers to auxiliary information that can be used to evaluate cleaning information in the target area. For example, the reference evaluation information may include population-related information, urban structure-related information, industrial structure-related information, etc.

In some embodiments, the management platform may obtain the reference evaluation information in various ways. For example, the management platform may obtain the reference evaluation information through a road monitoring device, a third-party platform (such as a census big data platform, the public service platform of the Ministry of Housing and Urban-Rural Development, and a logistics information platform, etc.), and a user input, etc. In some embodiments, the management platform may further obtain the reference evaluation information in other ways, which is not limited in the present disclosure.

In some embodiments, the reference evaluation information may include at least one of the population information, the building information, stall information, logistics information, and trash can configuration information.

The population information refers to data related to the population within the target area. For example, the population information may include permanent resident population information, temporary resident information, floating population information, etc. In some embodiments, the population information may be obtained based on the third-party platform, the road monitoring device, the user input, etc. For example, the management platform may obtain the permanent resident population information and the temporary resident population information through the census big data platform, a hotel information management platform, etc. For another example, the management platform may obtain the floating population information in the target area through the road monitoring device. For another example, the management platform may obtain the population information input by the user through the user platform.

The building information refers to data related to the buildings within the target area. For example, the building information may include information such as a type of area to which the building belongs, a scale of the building, and a use status of the building. Among them, the type of area may include a residential area, an office area, a commercial area, etc.; the building scale may include a floor area, a building floor, a building floor-area ratio, etc.; the building use status may include the building being used, vacant, a utilization rate, a usage, etc. In some embodiments, the management platform may obtain the building information through a third-party platform (e.g., the public service platform of the Ministry of Housing and Urban-Rural Development). In some embodiments, the management platform may obtain the building scale information based on a drone monitoring. In some embodiments, the management platform may further obtain the building information based on a user input.

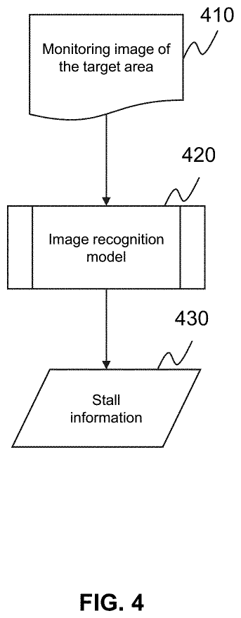

The stall information refers to the information related to a mobile stall in the target area. For example, the stall information may include information such as a type of mobile stall, an area of the stall, and a number of people staying there. In some embodiments, the management platform may obtain mobile stall information based on the road monitoring device. In some embodiments, the management platform may further process the monitoring image based on an image recognition model to determine the stall information. For more contents about the determining the stall information based on the image recognition model, please refer to FIG. 4 and related descriptions.

The logistics information refers to information related to logistics in the target area. For example, the logistics information may include express delivery information, a packaging waste volume, etc. The express delivery information may include a type of the express delivery, a quantity and size corresponding to each type of the express delivery, etc. The packaging waste volume generated by different types and sizes of express delivery may be different. In some embodiments, the management platform may obtain the express delivery information based on the logistics information management platform, and then determine the logistics packaging waste volume based on the express delivery information.

The trash can configuration information refers to data related to a distribution of trash cans in the target area. For example, the trash can configuration information may include information such as a type, a capacity, a quantity, and a placement interval of the trash cans. The type of trash can may refer to a functional classification of the trash can, such as a recyclable trash can, a toxic and harmful trash can, a kitchen waste trash can, other trash cans, etc.; the placement interval may include a placement distance between the trash cans, a density, etc. In some embodiments, the management platform may obtain the trash can configuration information based on the road monitoring device within the target area. In some embodiments, the management platform may further obtain trash can configuration information based on the third-party platform, such as a city management platform.

In some embodiments, the reference evaluation information may include historical waste cleaning volumes of the reference area and the target area.

The reference area refers to other areas with the reference evaluation information similar to the reference evaluation information of the target area. For example, the reference area may be another area that is the same or similar to the target area in the size, the type, the population information, the building information, the stall information, the logistics information, and the trash can configuration information.

In some embodiments, the reference area may be determined by counting the reference evaluation information of all areas and then performing a comparative analysis. For example, based on statistical information, each item of the reference evaluation information may be compared one by one, and the one closest to the target area may be determined as the reference area. In some embodiments, the reference evaluation information may further be determined in other ways, which is not limited in the present disclosure. For example, a vector may be constructed based on the basic information of each area, and the reference area may be determined by means of vector retrieval.

The historical waste cleaning volume refers to the waste cleaning volume in the historical time period before the current time. For example, if the current time is 18:00, September 10, 2025, the historical waste cleaning volume may refer to several hours or days before 18:00, September 10, 2025. In some embodiments, the historical waste cleaning volume may be obtained through statistics.

In 320, determining, based on the reference evaluation information, the cleaning information of the target area at the target time. The cleaning information includes the waste cleaning volume.

The target time may refer to a preset time when a waste removal is going to be performed. The target time may be a time after the first historical time period. For example, the first historical time period is 8:00-12:00 on September 10, 2025, and the target time may be a time after 12:00.

The cleaning information refers to information related to the waste cleaning in the target area at the target time. For example, the cleaning information may include information such as the waste cleaning volume, a cleaning area, and a cleaning time.

The waste cleaning volume refers to the volume of waste that needs to be cleaned in the target area at the target time.

In some embodiments, the management platform may determine the cleaning information in a variety of ways based on the reference evaluation information. In some embodiments, the management platform may calculate, based on the reference evaluation information, average cleaning information of other areas with similar reference evaluation information for consecutive years as the cleaning information of the target area.

In some embodiments, the management platform may determine the cleaning information through a waste estimation model based on the reference evaluation information. For details, please refer to FIG. 5 and the related descriptions, which will not be repeated here.

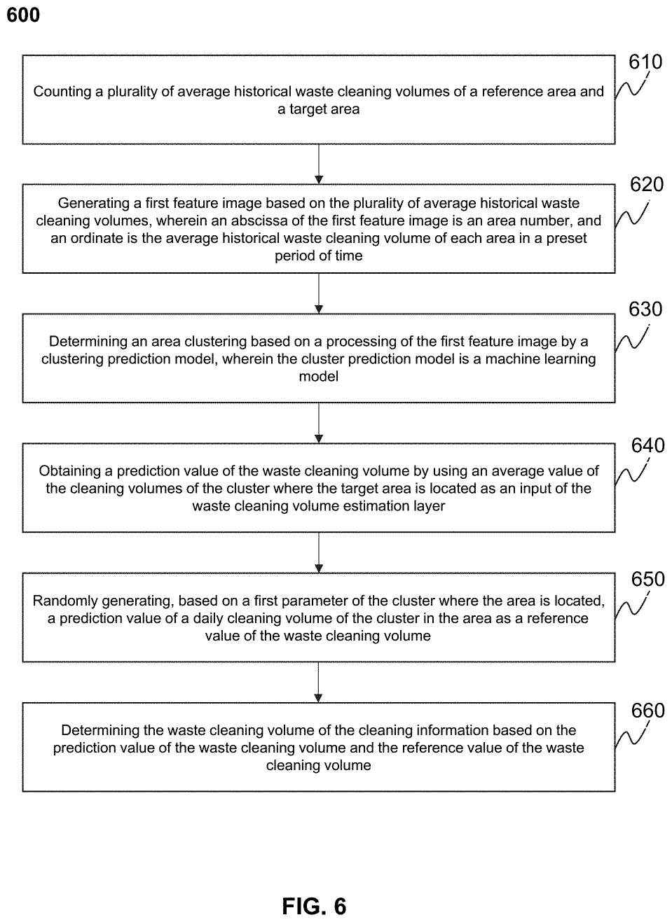

In some embodiments, the cleaning information may further be determined based on the historical waste cleaning volumes of the reference area and the target area. For details, please refer to FIG. 6 and the related descriptions, which will not be repeated here.

In some embodiments of the present disclosure, by ways of obtaining the reference evaluation information of the target area in the first historical time period, and using the model, etc. to determine the cleaning information of the target area at the target time, an accuracy of determining the cleaning information of the target area at the target time can be improved. Based on the determined cleaning information, the waste removal and transportation work may be arranged flexibly and accurately, and an automatic and intelligent management of urban garbage removal and transportation may be realized.

FIG. 4 is a schematic diagram illustrating an exemplary process for obtaining stall information according to some embodiments of the present disclosure.

In some embodiments, the stall information may be obtained based on an image recognition model. The image recognition model is used to output the stall information based on a processing of a monitoring image of a target area. The image recognition model is a machine learning model.

In some embodiments, the image recognition model may be at least one of a you only look once (YOLO) model, a PaddlePaddle-Lightweight convolutional neural network (PP-LCNet) lightweight backbone network model, or other custom models.

As shown in FIG. 4, an image recognition model 420 may process a monitoring image 410 of the target area to determine the stall information 430, that is, to determine a type, an area, and a number of people staying at the mobile stall. In some embodiments, the image recognition model may process the monitoring images of the target area at a plurality of time points within a plurality of preset time periods to determine the number of people staying at the stall at the plurality of time points. In some embodiments, the management platform may average the number of people staying at the stall at the plurality of time points to obtain a final number of people staying at the stall as stall information 430.

In some embodiments, the image recognition model may be obtained based on training. In some embodiments, a training sample may be a plurality of groups of road monitoring images, and a label may be a type, an area, an actual number of people staying at the stall of the mobile stall. The label may be manually annotated.

In some embodiments, the training sample and the label may be input into an initial image recognition model, and a loss function may be constructed based on the output of the initial image recognition model and the label. The initial image recognition model may be trained through a gradient descent, etc., based on the loss function. When a preset condition is met, the training completes, and a trained image recognition model may be obtained. The preset condition may be that the loss function converges or the training reaches the maximum number of times.

In some embodiments of the present disclosure, determining the stall information through the image recognition model may improve an efficiency of data processing, improve an accuracy of determining the stall information, and provide a strong support for a subsequent determination of the cleaning information based on the stall information, etc.

FIG. 5 is a schematic diagram illustrating an exemplary process for determining cleaning information based on a waste estimation model according to some embodiments of the present disclosure.

In some embodiments, determining the cleaning information of a target area at a target time based on reference evaluation information includes: determining, based on a processing on the reference evaluation information by a waste estimation model, the waste cleaning volume of the target area at the target time, the waste estimation model being a machine learning model.

In some embodiments, an input of the waste estimation model may be reference evaluation information 510, and an output may be waste cleaning volume 550 of the target area at the target time. The reference evaluation information 510 may include building information 510-1, logistics information 510-2, population information 510-3, stall information 510-4 and trash can configuration information 510-5.

In some embodiments, the waste estimation model may be any one or combination of a convolutional neural network (CNN), a deep neural network (DNN), a recurrent neural network (RNN), or other custom network.

In some embodiments, the waste estimation model may be obtained by training. In some embodiments, a training sample and a label may be input into the initial waste estimation model, and a loss function may be constructed based on an output of the initial waste estimation model and the label. The initial waste estimation model may be trained by a gradient descent based on the loss function. When the preset condition is met, the training is completed, and a trained waste estimation model may be obtained. The preset condition may be that the loss function converges or the training reaches the maximum number of times.

In some embodiments, the training samples may be a plurality of groups of historical reference evaluation information, and the label may be an actual waste cleaning volume corresponding to each group of historical reference evaluation information. The historical reference evaluation information may be obtained from historical data stored in a road monitoring device and a third-party platform, etc., or obtained through an input by a user; the label may be manually annotated.

In some embodiments, the waste estimation model may include an indoor estimation layer 520, an outdoor estimation layer 530, and a waste cleaning volume estimation layer 540.

In some embodiments, the indoor estimation layer 520 may be used to process the building information 510-1, the logistics information 510-2, and the population information 510-3, and output an indoor waste volume 520-4.

The indoor waste volume refers to the volume of waste generated inside the building in the target area within the target time. For example, the volume of indoor waste may include the volume of domestic waste generated in a residential area, an office area, a commercial area, etc.

In some embodiments, the outdoor estimation layer 530 may be used to process the stall information 510-4, the population information 510-3, and the trash can configuration information 510-5, and output an outdoor waste volume 530-4.

The outdoor waste volume refers to the volume of waste generated outside the building in the target area during the target time. For example, the outdoor waste volume may include the volume of waste generated in areas such as a street, a shop, and a mobile stall outside the residential area.

In some embodiments, the waste cleaning volume estimation layer 540 may be used to process the indoor waste volume 520-4, the outdoor waste volume 530-4, and the trash can configuration information 510-5, and output the waste cleaning volume 550.

In some embodiments, the waste estimation model may be obtained by jointly training the indoor estimation layer, the outdoor estimation layer, and the waste cleaning volume estimation layer. In some embodiments, a sample for the joint training may include the plurality of groups of historically collected reference evaluation information, i.e., sample population information, sample building information, sample stall information, sample logistics information, and sample trash can configuration information. The training sample may be obtained from a database of the road monitoring device and the third-party platform, etc., or may be obtained through a manual input. The label is the actual waste cleaning volume corresponding to each group of reference evaluation information, which can be manually annotated.

In some embodiments, the sample building information, the sample logistics information, and the sample population information may be input into an initial indoor estimation layer to obtain a sample indoor waste volume. The sample population information, the sample stall information, and the sample trash can configuration information may be input into an initial outdoor estimation layer to obtain a sample outdoor waste volume. The sample indoor waste volume and the sample outdoor waste volume may be used as the training sample to be input into an initial waste cleaning volume estimation layer with the sample trash can configuration information, and the waste cleaning volume output by the initial waste cleaning volume estimation layer may be obtained. The loss function may be constructed based on the waste cleaning volume and the label, and parameters of the initial indoor estimation layer, the initial outdoor estimation layer and the initial waste cleaning volume estimation layer may be updated synchronously. Through the parameter update, a trained waste estimation model may be obtained.

In some embodiments, the indoor estimation layer 520 may include a building feature sub-layer 520-1 and an indoor prediction sub-layer 520-3.

In some embodiments, the building feature sub-layer 520-1 may be used to process building information 510-1 to output a building feature vector 520-2. The building feature vector is a vector that reflects various feature information of the building in the target area, such as an area to which the building belongs, a scale of the building, and a use status of the building, etc. Exemplarily, the building feature vector may be (a, (b, c, d), e), where a may be a number from 0 to n, and different numbers represent different areas; (b, c, d) may be an actual value of the building scale, b indicates a floor area, c indicates a number of floors, and d indicates a building utilization rate; e indicates the use state, the value may be 0 and 1, 0 indicates the use state is unoccupied, 1 indicates the use state is occupied.

In some embodiments, the indoor prediction sub-layer 520-3 may be used to process the building feature vector 520-2, the logistics information 510-2, and the population information 510-3, and output the indoor waste volume 520-4.

In some embodiments of the present disclosure, by setting the building feature sub-layer and the indoor prediction sub-layer for the indoor estimation layer of the waste estimation model to process the corresponding reference evaluation information respectively, a processing pressure of processing information by only one indoor estimation layer may be relieved, thereby improving a data processing efficiency.

In some embodiments, the outdoor estimation layer 530 may include a stall feature sub-layer 530-1 and an outdoor estimation sub-layer 530-3.

In some embodiments, the stall feature sub-layer 530-1 may be used to process the stall information 510-4 and output a stall feature vector 530-2. The stall feature vector may reflect various feature information of the stall, such as a stall type, a stall area, a number of people staying at the stall, etc. Exemplarily, the stall feature vector may be (i, j, k), where, i indicates the stall type, and the number of 0˜m may be used to indicate different stall types; j indicates the stall area, and the value is the actual area of the store; k indicates the number of people, and the value is the actual number of people staying at the stall.

In some embodiments, the outdoor estimation sub-layer 530-3 may be used to process the stall feature vector 530-2, the population information 510-3, and the trash can configuration information 510-5, and output the outdoor waste volume 530-4.

In some embodiments of the present disclosure, by setting the stall feature sub-layer and the outdoor estimation sub-layer for the outdoor estimation layer of the waste estimation model to process the corresponding reference evaluation information respectively, the processing pressure of processing information by only one outdoor estimation layer may be relieved, thereby improving a data processing efficiency.

In some embodiments, the cleaning information further includes a cityscape influence degree. In some embodiments, the waste estimation model further includes a cityscape influence degree estimation layer 560. The cityscape influence degree estimation layer is used to process the outdoor waste volume and the population information, and output a cityscape influence degree.

The cityscape influence degree refers to an influence degree of the outdoor waste and the population information, etc., in the target area on the cityscape. For example, the cityscape influence degree may be evaluated based on the outdoor waste volume and the population information. Different outdoor waste volumes have different influence degrees on the cityscape, and the greater the outdoor waste volume is, the higher the influence degree is; correspondently, a great number of floating populations may cause a relatively high influence degree on the cityscape. In some embodiments, the cityscape influence degree may be comprehensively determined based on the outdoor waste volume and the population information. For example, the influence degree of the outdoor waste volume on the cityscape and the influence degree of the population information on the cityscape may be weighted and summed, and a final influence degree on the cityscape may be comprehensively determined. The weight may be determined based on an evaluation criterion of each city area for the cityscape. For example, if relevant departments and citizens believe that the outdoor waste volume has a greater influence on the cityscape, the weight corresponding to the influence of the outdoor waste volume on the cityscape may be correspondingly greater. The sum of the weights is 1.

In some embodiments, the cityscape influence degree estimation layer 560 may be used to process the outdoor waste volume 530-4 and the population information 510-3, and output the cityscape influence degree 570.

In some embodiments, by setting a cityscape influence degree estimation layer, the influence degree of the outdoor waste volume and the population information on cityscape may be predicted simultaneously, which further reflects an effectiveness of a city waste removal and transportation management. By adjusting a city waste removal and transportation management policy based on the influence degree on the cityscape, a dynamic management may be realized, thereby improving the intelligent and automation of the city waste removal and transportation management.

In some embodiments, the indoor estimation layer, the outdoor estimation layer, the waste cleaning volume estimation layer, and the cityscape influence degree estimation layer of the waste estimation model may be obtained through an individual training. In some embodiments, historically collected reference evaluation information may be input into a corresponding initial estimation layer (e.g., an initial indoor estimation layer), and the loss function may be constructed through an output of the initial estimation layer and the label. Based on the loss function, the initial estimation layer is trained by gradient descent, etc., until the loss function converges or the maximum number of training times is reached, the training is completed, and a trained estimation layer (such as the indoor estimation layer) is obtained. For example, the sample building information, the sample population information and the sample logistics information of a certain area in a certain period of time collected historically may be input into the initial indoor estimation layer for training. The label may be the indoor waste volume in the time period, which may be obtained by a manual annotation.

In some embodiments, the sample of the individual trained indoor estimation layer may be the building information, the population information and the logistics information of a certain area in a certain period of time collected in history, and the label may be the indoor waste volume of that time period. In some embodiments, the sample of the individual trained outdoor estimation layer may be the stall information, the population information and the trash can configuration information of a certain area in a certain period of time collected in history, and the label may be the outdoor waste volume of the area of the time period. In some embodiments, the sample of the individually trained waste cleaning volume estimation layer may be the trash can configuration information, the indoor waste volume predicted based on the indoor estimation layer, and the outdoor waste volume predicted by the outdoor estimation layer of a certain area in a certain period of time collected in history. The label may be an actual total waste volume cleaned in the area at the time period. In some embodiments, the sample of the individually trained cityscape influence degree estimation layer may be the population information, the outdoor waste volume based on the outdoor estimation layer of a certain area in a certain period of time collected in history. The label may be the cityscape influence degree of the area at the time period. The aforementioned training samples may be obtained through the road monitoring device, the third-party platform, and the user input, etc., and the labels may be obtained through the manual annotation.

Through the individual training, each estimation layer (such as the indoor estimation layer) may learn the feature information of a deeper layer, thereby improving the prediction accuracy of the finally obtained waste estimation model.

In some embodiments, the indoor estimation layer, the outdoor estimation layer, the waste cleaning volume estimation layer, and the cityscape influence degree estimation layer of the waste estimation model may be obtained based on the joint training. In some embodiments, the sample of the joint training may be the building information, the logistics information, the population information, the stall information and the trash can configuration information of a certain area in a certain period of time collected in history. The label may include the actual volume of waste cleaned and the cityscape influence degree of the area in the time period. The training data may be obtained based on the road monitoring device, the historical data stored on the third-party platform, or manually input, and the labels may be manually annotated.

In some embodiments, the sample building information, the sample logistics information, and the sample population information in the training sample may be input into the initial indoor estimation layer for processing to obtain an initial indoor waste volume; the sample stall information, the sample population information, and the sample trash can configuration information may be input into the initial outdoor estimation layer to obtain an initial indoor waste volume; the initial indoor waste volume, the initial outdoor waste volume, and the sample trash can configuration information may be input into the initial waste cleaning volume estimation layer for processing to obtain an initial waste cleaning volume; the initial outdoor waste volume and the sample population information may be input into the cityscape influence degree estimation layer for processing to obtain an initial cityscape influence degree. The loss function may be constructed based on the initial waste cleaning volume, the initial cityscape influence degree and the training labels. Based on the loss function, the parameters of the initial indoor estimation layer, the initial outdoor estimation layer, the initial waste cleaning volume estimation layer and the initial cityscape influence degree estimation layer may be updated synchronously through the gradient descent and other approaches. Until the preset condition is met, the training is completed, and a trained waste estimation model may be obtained. The preset condition may be that the loss function converges or the training reaches the maximum number of the training times, etc.

In some embodiments of the present disclosure, the waste estimation model may be obtained through the joint training, which may solve the problem that in some cases, the label of a certain layer of the individual training model cannot be obtained easily. By using the waste cleaning volume and the cityscape influence degree as the labels for the joint training, the obtained waste estimation model may be more accurate.

In some embodiments of the present disclosure, a waste estimation model is trained to predict the cityscape influence degree and the waste cleaning volume of the target area within the target time. A self-learning ability of the machine learning model may be used to learn a deep relationship between the cityscape influence degree, the waste cleaning volume and the building information, the logistics information, the population information, the stall information, and the trash can configuration information, thereby improving efficiencies and the accuracies of a waste cleaning volume prediction and a cityscape impact prediction. By setting a plurality of internal processing layers for the waste estimation model, the corresponding reference evaluation information may be processed separately based on the plurality of processing layers, thereby improving an efficiency of the data processing.

FIG. 6 is a flowchart illustrating an exemplary process for determining the cleaning information according to some embodiments of the present disclosure. In some embodiments, a process 600 may be performed by a management platform. As shown in FIG. 6, the process 600 includes the following operations.

In 610, counting a plurality of average historical waste cleaning volumes of a reference area and a target area.

The average historical waste cleaning volume refers to an average value of the historical waste cleaning volume of each area in each unit time. The unit time may be determined based on an actual situation, for example, the unit time may be one day or one week. For example, when the unit time is one day, if there are 4 reference areas and 1 target area, waste cleaning volume data of the 5 areas in the 30-day history may be sampled, and an average waste cleaning volume per day in each area may be calculated and taken as the average historical waste cleaning volume.

In some embodiments, the management platform may obtain an average historical waste cleaning volume per unit time by counting the historical waste cleaning volume of each reference area and the target area in a period of time (e.g., 30 days) and take the average historical waste cleaning volume per unit time as the average historical waste cleaning volume.

In 620, generating a first feature image based on the plurality of average historical waste cleaning volumes, wherein an abscissa of the first feature image is an area number, and the ordinate is the average historical waste cleaning volume of each area in a preset period of time. The preset time period may be set based on a specific sampling condition, for example, 30 days, 60 days, etc., which is not limited in the present disclosure.

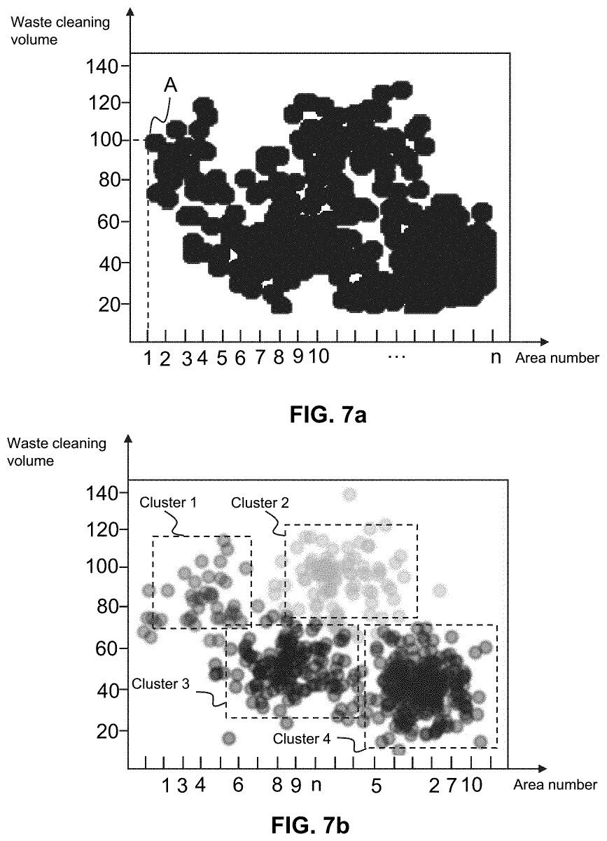

The first feature image refers to an image that may reflect the average historical waste cleaning volume of each area in the preset time period. The average historical waste cleaning volume of each area in the preset time period may be recorded as a point in the first feature image at the position corresponding to the waste cleaning volume in the corresponding area. FIG. 7a is a schematic diagram illustrating an exemplary first feature image according to some embodiments of the present disclosure. In some embodiments, as shown in FIG. 7a, the abscissa of the first feature image is an area number of each area, such as area 1, area 2, area 3, . . . , area n, etc.; an ordinate is an average historical waste cleaning volume of each area in a preset time period. For example, point A in the image may indicate the average historical waste cleaning volume of area 1 in the preset time period (e.g., 30 days).

In some embodiments, the first feature image may be generated based on the counted average historical waste cleaning volume of a plurality of areas in a preset time period, and according to the area number, and the average historical waste cleaning volume in the preset time period corresponding to each area. For example, the average historical waste cleaning volume in the preset time period corresponding to area 3 is 100 tons (or other units), the abscissa is area 3, and the ordinate is 100. The corresponding position is recorded as a point. In this way, the average historical waste cleaning volumes of all areas in a preset time period are recorded to form a first feature image.

In 630, determining an area clustering based on a processing of the first feature image by a clustering prediction model. The cluster prediction model is a machine learning model.

In some embodiments, the cluster prediction model may be a Gaussian mixture model. In some embodiments, the clustering prediction model may further be other models with a clustering function, such as a K-mean clustering, a hierarchical (system) clustering, a custom clustering model, etc., which is not limited in the present disclosure.

The area clustering refers to classifying the areas with similar or the same historical average waste cleaning volumes into one cluster. For example, area 1, area 2, area 3, and the target area (area 4) have very close average historical waste cleaning volumes, so they are classified into one cluster.

In some embodiments, an input of the cluster prediction model is the first feature image, and an output is the area clustering. FIG. 7b is a schematic diagram illustrating an exemplary area clustering according to some embodiments of the present disclosure. In the schematic diagram shown in FIG. 7b, an abscissa indicates an area number, and an ordinate indicates an average historical waste cleaning volume of each area in a preset time period. As can be seen from the figure, by clustering the first feature image, four area clusters may be determined, namely cluster 1, cluster 2, cluster 3 and cluster 4. For the areas belonging to the same area cluster, the area numbers in the schematic diagram of the area clustering result (FIG. 7b) are close to each other. As shown in the figure, area 1, area 3 and area 4 all belong to cluster 1.

In some embodiments, the cluster prediction model may be obtained based on training. In some embodiments, a plurality of groups of training samples and labels corresponding to the samples may be input into an initial cluster prediction model, and a loss function may be constructed based on the area clusters and the labels output by the initial cluster prediction model. Based on the loss function, the parameter of the initial clustering prediction model may be updated by a gradient descent, etc., until the training ends when the preset conditions are met, and the trained clustering prediction model may be obtained. The preset condition may be that the loss function converges or the training reaches the maximum number of times.

In some embodiments, the training samples for training the cluster prediction model may be a plurality of groups of first feature images. In some embodiments, the plurality of groups of first feature images may be generated based on a plurality of groups of collected average historical waste cleaning volumes in different areas and on different dates. The labels are actual area clusters, which can be obtained by a manual annotation.

In 640, obtaining a prediction value of the waste cleaning volume by using an average value of the cleaning volumes of the cluster where the target area is located as an input of the waste cleaning volume estimation layer.

The average value of the cleaning volumes refers to an average historical cleaning volume of the plurality of areas in the cluster where the target area is located. For example, the cluster where the target area is located includes a total of 5 areas, and each area corresponds to an average historical waste cleaning volume. The 5 average historical waste cleaning values may be further averaged to obtain the average value of the cleaning volumes.

In some embodiments, the management platform may input an average value of the waste cleaning volumes into the waste cleaning volume estimation layer of the waste estimation model, and process the average value of the waste cleaning volumes based on the waste cleaning volume estimation layer to determine the prediction value of the waste cleaning volume. In some embodiments, the waste cleaning volume estimation layer may be obtained through training. In some embodiments, a plurality of groups of the average value of the waste cleaning volumes may be input into the initial waste cleaning volume estimation layer as the training samples, and the prediction value of the waste cleaning volume may be output; A loss function may be constructed based on the prediction value of the waste cleaning volume and the corresponding label to train the initial waste cleaning volume estimation layer. Until the loss function converges or the maximum number of training times is reached, the training ends, and the trained waste cleaning volume estimation layer is obtained. The label is the actual volume of waste cleaned, which may be obtained based on manual annotation.

In 650, randomly generating, based on a first parameter of the cluster where the area is located, a prediction value of a daily cleaning volume of the cluster in the area as a reference value of the waste cleaning volume.

The first parameter refers to a clustering parameter obtained when a clustering model performs a clustering prediction. For example, when performing the cluster prediction on the first feature image based on a Gaussian clustering model, a Gaussian distribution parameter may be obtained. The Gaussian distribution parameter includes a mean and a variance of the historical average waste cleaning volumes.

The prediction value of the daily cleaning volume refers to the daily waste cleaning volume of the target area determined based on the first parameter.

The reference value of the waste cleaning volume refers to the daily waste cleaning volume that may be used as a reference of the target area.

In some embodiments, the management platform may randomly generate a value from a cluster distribution (e.g., the Gaussian distribution) through a random generator based on the first parameter of the cluster where the target area is located as the prediction value of the daily cleaning volume. For example, a uniform random number may be generated by a random number generator based on the first parameter; then, the uniform random number may be transformed into a Gaussian random number by a Box-Muller algorithm, which is the prediction value of the daily cleaning volume. In some embodiments, the prediction value of the daily cleaning volume may be used as the reference value of the waste cleaning volume of the target area.

In 660, determining the waste cleaning volume of the cleaning information based on the prediction value of the waste cleaning volume and the reference value of the waste cleaning volume.

In some embodiments, the management platform may compare the prediction value of the waste cleaning volume with the reference value of the waste cleaning volume, and determine a waste reference volume of the cleaning information based on the comparison result. For the specific contents of determining the waste reference volume of the cleaning information, please refer to the related descriptions below.

In some embodiments, the management platform may set a difference threshold, and compare the difference between the prediction value of the waste cleaning volume and the reference value of the waste cleaning volume with the difference threshold, so as to determine the waste cleaning volume of the cleaning information. The difference threshold refers to a difference limit range between a preset prediction value of the waste cleaning volume and the reference value of the waste cleaning volume, for example, the difference threshold may be 1 ton.

In some embodiments, when the difference between the prediction value of the waste cleaning volume and the reference value of the waste cleaning volume is less than or equal to the difference threshold, the prediction value of the waste cleaning volume may be determined as a final waste reference volume of the cleaning information.

In some embodiments, when the difference between the prediction value of the waste cleaning volume and the reference value of the waste cleaning volume is greater than the difference threshold, the prediction value of the waste cleaning volume and the reference value of the waste cleaning volume may be weighted and summed to determine the final waste cleaning volume of the cleaning information. In some embodiments, the weight of the reference value of the waste cleaning volume is positively related to the difference between the prediction value of the waste cleaning volume and the reference value of the waste cleaning volume. That is, the greater the difference value is, the greater the weight of the reference value of the waste cleaning volume is. The sum of the weights is 1.

In some embodiments of the present disclosure, through determining the difference value by comparing the prediction value of the waste cleaning volume with the reference value of the waste cleaning volume, and setting the difference threshold reasonably, based on the difference threshold, the final waste cleaning volume of the cleaning information may be determined more accurately and reliably.

In some embodiments of the present disclosure, by clustering the reference area and the target area, etc., the prediction value of the waste cleaning volume and the reference value of the waste cleaning volume may be determined, and based on the prediction value of the waste cleaning volume and the reference value of the waste cleaning volume, the final waste cleaning volume of the cleaning information may be determined. In this way, the average historical waste cleaning volume in the reference area may be used as a reference to determine the waste cleaning volume in the target area, so that the determination result may be more realistic and accurate.

It should be noted that the above description about the process 600 is only for example and illustration, and does not limit the scope of the present disclosure. For those skilled in the art, various modifications and changes can be made to the process 600 under the guidance of the present disclosure. However, these modifications and changes are still within the scope of the present disclosure. For example, the process 600 may further include setting the difference threshold, and determining the waste cleaning volume based on the difference threshold.

One of the embodiments of the present disclosure further provides computer-readable storage medium storing computer instructions, when reading the computer instructions in the storage medium, a computer implements the method for waste cleaning volume prediction in a smart city according to the embodiments of the present disclosure.

The possible beneficial effects of the embodiments of the present disclosure include, but are not limited to: (1) By obtaining the reference evaluation information of the target area in the first historical time period, and using models and other approaches to determine the cleaning information of the target area at the target time, the accuracy of the cleaning information of the target area at the target time determined may be improved; Based on the determined cleaning information, the waste removal and transportation may be arranged flexibly and accurately, and the automatic and intelligent management of urban garbage removal and transportation may be realized; (2) By setting a plurality of internal processing layers for the model, the data processing efficiency may be improved, thereby improving the efficiency of the waste cleaning volume prediction; (3) By clustering the reference area and the target area, the area cluster to which the target area belongs may be determined, and the final waste cleaning volume of the cleaning information may be determined based on the average historical waste cleaning volume of the reference area of the area clustering. In this way, the final waste cleaning volume of the cleaning information may be more realistic and reliable, thereby improving an effectiveness of the city waste removal and transportation management.

The basic concepts have been described above. Obviously, for those skilled in the art, the above detailed disclosure is merely an example, and does not constitute a limitation of the present disclosure. Although not explicitly described herein, various modifications, improvements, and corrections to the present disclosure may be made by those skilled in the art. Such modifications, improvements, and corrections are suggested in the present disclosure, so they still belong to the spirit and scope of the embodiments of the present disclosure.

Meanwhile, the present disclosure uses specific words to describe the embodiments of the present disclosure. Such as “one embodiment,” “an embodiment,” and/or “some embodiments” means a certain feature, structure, or characteristic associated with at least one embodiment of the present disclosure. Therefore, it should be emphasized and noted that two or more references to “an embodiment” or “one embodiment” or “an alternative embodiment” in various places in the present disclosure are not necessarily referring to the same embodiment. Furthermore, certain features, structures or characteristics of the one or more embodiments of the present disclosure may be combined as appropriate.

In addition, unless explicitly stated in the claims, the order of the processing elements and sequences described in the present disclosure, the use of alphanumerics, or the use of other names is not intended to limit the order of the processes and methods of the present disclosure. While the foregoing disclosure discusses by way of various examples some embodiments of the invention that are presently believed to be useful, it is to be understood that such details are for purposes of illustration only and that the appended claims are not limited to the disclosed embodiments, but rather, the claims are intended to cover all modifications and equivalent combinations falling within the spirit and scope of the embodiments of the present disclosure. For example, although the implementation of various assemblies described above may be embodied in a hardware device, it may also be implemented as a software only solution, e.g., an installation on an existing server or mobile device.

Similarly, it should be noted that, in order to simplify the expressions disclosed in the present disclosure and thus help the understanding of one or more embodiments of the present disclosure, in the foregoing description of the embodiments of the present disclosure, various features may sometimes be combined into one embodiment, drawing, or descriptions thereof. However, this method of disclosure does not imply that the subject matter of the description requires more features than are recited in the claims. Rather, claimed subject matter may lie in less than all features of a single foregoing disclosed embodiment.

Some embodiments use numbers to describe quantities of ingredients and attributes, it should be understood that such numbers may be modified by words like “about”, “approximately” or “substantially”. Unless stated otherwise, the “about”, “approximately” or “substantially” means that a variation of ±20% is allowed for the stated number. Accordingly, in some embodiments, the numerical parameters set forth in the disclosure and claims are approximations that can vary depending upon the desired features of some embodiments. In some embodiments, the numerical parameters should take into account the specified significant digits and use a general digit reservation method. Notwithstanding that the numerical fields and parameters used in some embodiments of the present disclosure to confirm the breadth of their ranges are approximations, in specific embodiments such numerical values are set as precisely as practicable.

For each patent, patent application, patent application publication, and other material, such as article, book, disclosure, publication, document, etc., cited in the present disclosure, the entire contents of which are hereby incorporated by reference into the present disclosure, excepting the history documents that are inconsistent with or conflict with the contents of the present disclosure, as well as the documents (currently or hereafter appended to the present disclosure) limiting the broadest scope of the claims of the present disclosure. It should be noted that, if there is any inconsistency or conflict between the descriptions, definitions and/or use of terms in the accompanying materials of the present disclosure and the contents of the present disclosure, the descriptions, definitions and/or use of terms in the present disclosure shall prevail.

Finally, it should be understood that the embodiments described in the present disclosure are only used to illustrate the principles of the embodiments of the present disclosure. Other variations are also possible within the scope of the present disclosure. Therefore, by way of example and not limitation, alternative configurations of the embodiments of the present disclosure may be considered consistent with the teachings of the present disclosure. Accordingly, the embodiments of the present disclosure are not limited to those expressly introduced and described in the present disclosure.

What is claimed is:

1. A method for waste cleaning volume prediction in a smart city, wherein the method is executed based on a management platform of an Internet of Things (IoT) system for waste cleaning volume prediction in a smart city, comprising:
obtaining reference evaluation information of a target area within a first historical time period; and
determining, based on the reference evaluation information, cleaning information of the target area at a target time, the cleaning information including a waste cleaning volume.

2. The method of claim 1, wherein the reference evaluation information includes at least one of population information, building information, stall information, logistics information, and trash can configuration information.

3. The method of claim 2, wherein the stall information is obtained based on an image recognition model, the image recognition model being a machine learning model and configured to output the stall information based on a processing of a monitoring image of the target area.

4. The method of claim 2, wherein the determining, based on the reference evaluation information, cleaning information of the target area at a target time comprises:
determining, based on a processing of the reference evaluation information by a waste estimation model, the waste cleaning volume of the target area at the target time, the waste estimation model being a machine learning model.

5. The method of claim 4, wherein the waste estimation model comprises: an indoor estimation layer, an outdoor estimation layer, and a waste cleaning volume estimation layer;
the indoor estimation layer is used to process the building information, the population information, and the logistics information, and output an indoor waste volume;
the outdoor estimation layer is used to process the stall information, the population information, and the trash can configuration information, and output an outdoor waste volume; and
the waste cleaning volume estimation layer is used to process the indoor waste volume, the outdoor waste volume, and the trash can configuration information, and output the waste cleaning volume.

6. The method of claim 5, wherein the cleaning information further includes a cityscape influence degree;
the waste estimation model further includes a cityscape influence degree estimation layer, and the cityscape influence degree estimation layer is used to process the outdoor waste volume and the population information, and output the cityscape influence degree.

7. The method of claim 5, wherein the indoor estimation layer includes a building feature sub-layer and an indoor estimation sub-layer;
the building feature sub-layer is used to process the building information and output a building feature vector; and
the indoor estimation sub-layer is used to process the building feature vector, the population information, and the logistics information, and output the indoor waste volume.

8. The method of claim 5, wherein the outdoor estimation layer includes a stall feature sub-layer and an outdoor estimation sub-layer;
the stall feature sub-layer is used to process stall information, and output a stall feature vector; and
the outdoor estimation sub-layer is used to process the stall feature vector, the population information, and the trash can configuration information, and output the outdoor waste volume.

9. The method of claim 1, wherein the reference evaluation information includes historical waste cleaning volumes of a reference area and the target area.

10. The method of claim 1, wherein the IoT system for waste cleaning volume prediction in the smart city further includes a user platform, a service platform, a sensing network platform, and an object platform;
the management platform includes a general management platform database and a plurality of management sub-platforms;
the sensing network platform includes a plurality of sensing network sub-platforms;
different target areas correspond to different sensing network sub-platforms; different sensing network sub-platforms correspond to different management sub-platforms;
the reference evaluation information of the target area in the first historical time period is obtained based on the object platform, and uploaded to a corresponding management sub-platform based on a sensing network sub-platform corresponding to the target area; the method comprising:
transmitting, through the general management platform database, the cleaning information of the target area in the target time to the service platform, and uploading the cleaning information to the user platform based on the service platform.

11. An Internet of Things (IoT) system for waste cleaning volume prediction in a smart city, wherein the IoT system includes a user platform, a service platform, a management platform, a sensing network platform, and an object platform;
the management platform includes a general management platform database and a plurality of management sub-platforms, wherein each management sub-platform in the plurality of management sub-platforms corresponds to a different target area;
the sensing network platform includes a plurality of sensing network sub-platforms, and each sensing network sub-platform corresponds to a different target area;
the object platform is used to obtain reference evaluation information of the target area in a first historical time period, and transmit the reference evaluation information to the corresponding management sub-platform based on the sensing network sub-platform corresponding to the target area;
the management sub-platform is used to determine, based on the reference evaluation information, cleaning information of the target area at a target time, and transmit, based on the general management platform database, the cleaning information to the service platform; the cleaning information including a waste cleaning volume; and
the service platform is used to transmit the cleaning information to the user platform.

12. The IoT system of claim 11, wherein the reference evaluation information includes at least one of population information, building information, stall information, logistics information, and trash can configuration information.

13. The IoT system of claim 12, wherein the stall information is obtained based on an image recognition model, the image recognition model is a machine learning model and configured to output the stall information based on a processing of a monitoring image of the target area.

14. The IoT system of claim 12, wherein the determine, based on the reference evaluation information, cleaning information of the target area at a target time comprises:
determining, based on a processing of the reference evaluation information by a waste estimation model, the waste cleaning volume of the target area at the target time, the waste estimation model being a machine learning model.

15. The IoT system of claim 14, wherein the waste estimation model includes: an indoor estimation layer, an outdoor estimation layer, and a waste cleaning volume estimation layer;
the indoor estimation layer is used to process building information, population information, and logistics information, and output an indoor waste volume;
the outdoor estimation layer is used to process stall information, the population information, and trash can configuration information, and output an outdoor waste volume; and
the waste cleaning volume estimation layer is used to process the indoor waste volume, the outdoor waste volume, and the trash can configuration information, and output the waste cleaning volume.

16. The IoT system of claim 15, wherein the cleaning information further includes a cityscape influence degree;
the waste estimation model further includes a cityscape influence degree estimation layer, and the cityscape influence degree estimation layer is used to process the outdoor waste volume and the population information, and output the cityscape influence degree.

17. The IoT system of claim 15, wherein the indoor estimation layer includes a building feature sub-layer and an indoor estimation sub-layer;
the building feature sub-layer is used to process the building information and output a building feature vector; and
the indoor estimation sub-layer is used to process the building feature vector, the population information, and the logistics information, and output the indoor waste volume.

18. The IoT system of claim 15, wherein the outdoor estimation layer includes a stall feature sub-layer and an outdoor estimation sub-layer;
the stall feature sub-layer is used to process stall information, and output a stall feature vector; and
the outdoor estimation sub-layer is used to process the stall feature vector, the population information, and the trash can configuration information, and output the outdoor waste volume.

19. The IoT system of claim 11, wherein the reference evaluation information includes historical waste cleaning volumes of a reference area and the target area.

20. A non-transitory computer-readable storage medium storing computer instructions, wherein when reading the computer instructions in the storage medium, a computer implements the method for waste cleaning volume prediction in a smart city according to claim 1.
